(19) United States
(12) Patent Application Publication
(10) Pub. No.: US 2016/0028451 A1
(43) Pub. Date: Jan. 28, 2016

(54) Active Antenna System And Method With Full Antenna Ports Dimension

(71) Applicants: Alcatel-Lucent USA Inc., Murray Hill, NJ (US); Alcatel Lucent, Boulogne-Billancourt (FR)

(72) Inventors: Teck Hu, Melbourne, FL (US); Min Zhang, Canterbury (GB)

(73) Assignees: Alcatel-Lucent USA Inc., Murray Hill, NJ (US); Alcatel Lucent, Boulogne-Billancourt (FR)

(21) Appl. No.: 14/805,821

(22) Filed: Jul. 22, 2015

Related U.S. Application Data
(63) Continuation-in-part of application No. 14/337,328, filed on Jul. 22, 2014.

(51) Int. Cl. H04B 7/04; H04W 72/04

(52) U.S. Cl. CPC H04B 7/0452; H04W 72/0406; H04B 7/04; H04W 88/08

(57) ABSTRACT

An Active Antenna System (AAS) operated as a static AAS is used to generate a static beam from signals applied to its input and based on received AAS configuration information. The AAS configuration information is received by a processor coupled to all of the components of the AAS and said processor converts the received AAS configuration information to control signals causing said components to generate the static beam.

This application is a continuation-in-part of application Ser. No. 14/337,328, filed on Jul. 22, 2014 and entitled Active Antenna System and Method with Full Antenna Ports Dimension, which is incorporated herein by reference in its entirety.

### BACKGROUND

1. Field of the Disclosure

The present disclosure generally relates to antenna systems and in particular, to an active antenna system.

2. Description of the Related Art

This section introduces aspects that may help facilitate a better understanding of the disclosure and no statement in this section indicates or admits in any manner certain subject matter regarding the pertinent prior art for this disclosure.

Traditionally, specifications for base stations of wireless communication systems would typically include, inter alia, detailed descriptions of the signals, the power of the signals and their spectral and temporal components transmitted or received (or both) by a base station. Even though base stations would usually have antennas as part of their equipment, the particular specification describing the operation of the antennas would not usually be part of the specification of a base station. In particular, signals conveyed (transmitted or received or both) by a base station were defined up to the point of a physical interface between base station circuitry and the antenna for that base station. A cable (e.g., a coaxial cable) would usually form the interface that provided a physical connection between base station circuitry and an antenna. The antenna would be driven by signals from the base station circuitry and thus radiate a certain antenna beam (or radiation pattern) of a certain power at a particular direction. For isotropic antennas, the EIRP (Equivalent Isotropically Radiated Power) of the antenna would be defined. Depending on the antenna radiation pattern and output power desired, different antennas with different operational characteristics would be used.

### SUMMARY

Disclosed herein are various embodiments of an Active Antenna System (AAS) that is integral with a base station or other equipment of a communication network (e.g., a cellular communication network) within which the AAS operates. The base station is serving a particular cell (defined geographic area) of the wireless communication network. A first embodiment comprises a plurality of transceivers (i.e., a Transceiver Bank) coupled to at least one Antenna Array (each array comprising a plurality of antenna elements) via a Radio Distribution Network (RDN), which Radio Distribution Network comprises controllable switches for routing signals applied to the Transceiver Bank to the Antenna Array to form a desired beam spatially directed at a particular desired geographical location or area, at a particular terminal (mobile or fixed), or at one or more groups of terminals at the same or different locations.

An example embodiment uses particular information that defines various dynamic beam forming operations performed by the Transceiver Bank, the Radio Distribution Network (RDN) and the Antenna Array on one or more signals applied to at least one input of the AAS (e.g., a Transceiver input) to generate a beam from the processing of the one or more reference signals where such beam may be directed at a particular terminal (mobile or fixed), one or more groups of terminals, or a geographical area. The directed beam resulting form the processing of the reference signal is a logical port of the AAS in general and more particularly a logical port of the Antenna Array. The particular information thus defines a dynamic mapping of one or more logical ports (i.e., one or more processed reference signals into a beam) to the AAS.

The term ‘dynamic beam forming operations’ refers to certain tasks performed by one or more of the components of the AAS to form beams based the particular information applied to the AAS for a defined period of time (or a desired period of time). The dynamic beam forming operations can be performed for a defined period of time, or for as long as needed or desired, using any one or more of the antenna elements. A beam formed from a dynamic beam forming operation has a particular shape, physical range, power allocation, and power distribution for coverage of (i) a specific geographical area; (ii) a specific terminal (mobile or fixed) at a particular location; (iii) one or more groups of terminals (fixed or mobile) within one defined area or different defined areas. The particular information on which the dynamic beam forming operations are based (or which defines the dynamic beam forming operations) is referred to as AAS configuration information.

The AAS configuration information is information that identifies the particular selected transceivers, the amount of power allocated to the particular selected transceivers, the particular routing of signal(s) applied to particular selected transceivers through selected switches of the RDN to the particular antenna elements needed to perform beam forming operations for a desired beam directed at a specific terminal (mobile or fixed), a particular geographical location or area, or one or more groups of terminals at the same location or at different locations.

When the applied signal is a reference signal (which may comprise one or more signals), which is a signal defined by the communication network (i.e., is part of the specifications of the communication network), or defined by one or more communication standard (and their associated protocols) being followed by the communication network within which the AAS operates, the resulting beam formed from the dynamic beam forming operations to process this reference signal inputted to the AAS (one embodiment of which is depicted in FIG. 1), is a logical port of the Antenna Array.

A logical port (or a generated beam of a reference signal) may or may not be generated for a defined time period. In many cases, the beam that is formed may be generated for as long as circumstances dictate. Each of the transceivers may include, as part of their circuitry, power amplifiers that can drive one or more of the antenna array elements via the Radio Distribution Network. The power amplifiers may include filters that serve to limit and/or define the frequency content of the signals applied to the transceivers. Further, each of the transceivers is also capable of imparting a certain phase to each of the applied signals. Thus, based on these capabilities of the transceivers and radiation profiles of the antenna array elements, the shape and direction of a beam can be designed as desired before it is generated. Yet further, the transceiver or transceivers to which a signal is applied may adjust the power level and the frequency content of the signal. The beam is thus designed and realized through the use of the circuitry discussed above, which may be part of a base station of a cellular communication network, or integral with the base station. The AAS operates within the cellular communication network or wireless communication network.

Another example embodiment discloses a method that performs the steps for various beam forming operations dictated by AAS configuration information (received by the AAS) to process one or more reference signals inputted into the AAS whereby some of these operations may be performed for a defined time period or for as long as desired. All of the steps of the second embodiment may be performed by an AAS that is integral with a base station of a cellular communication network within which the AAS operates. The AAS configuration information may originate from the communication network or may be generated by the network based on the network complying with the communication standard (e.g., certain protocols) being followed by the communication network. For example, the base station (or other network equipment) may generate AAS configuration information based on rules (communication standard and associated protocols) of the cellular network and/or based on information (from operators or users of the network, for example) describing the current tasks needed to be performed to meet the demands of the network.

The second embodiment determines whether there are sufficient resources available to perform the desired beam forming operations to generate one or more beams. In particular, in order to form the desired beam, the AAS first determines, based on the AAS configuration information, the following: (i) the particular transceivers to be used; (ii) the particular switches in the RDN to be used, (iii) the particular antenna elements to be used; (iv) the amount of power used by the selected transceivers to drive the selected antenna elements; and (v) the proper amount of power to be allocated to the AAS to perform the beam forming operations for the desired beam. If there are sufficient resources, then the AAS is operated so that the one or more beams are formed; otherwise the method disclosed in this embodiment waits until sufficient resources are available to form the desired one or more beams.

### BRIEF DESCRIPTION OF THE DRAWINGS

The present disclosure may be better understood, and its numerous features and advantages made apparent to those skilled in the art by referencing the accompanying drawings. The use of the same reference in different drawings indicates similar or identical items. Other aspects, features, and benefits of various disclosed embodiments will become more fully apparent, by way of example, from the following detailed description and the accompanying drawings, in which:

FIG. 1 shows one embodiment of an AAS.

FIG. 1A shows another embodiment of the AAS.

FIG. 2 shows a particular architecture utilizing multiple AASs.

FIG. 3 shows the AAS architecture of FIG. 2 applied to a cellular communication network.

FIG. 4 is a flow chart of a method embodiment.

### DETAILED DESCRIPTION

This disclosure describes an Active Antenna System (AAS) that is integral with a base station or other equipment of a communication network (e.g., a cellular communication network) within which the AAS operates. The base station is serving a particular cell (defined geographic area) of the wireless communication network. One example embodiment is an AAS device comprising a plurality of transceivers (i.e., a Transceiver Bank) coupled to at least one Antenna Array (each array comprising a plurality of antenna elements) via a Radio Distribution Network (RDN), which RDN comprises controllable switches for routing signals - - - applied to the Transceiver Bank - - - to the Antenna Array to form a desired beam spatially directed at a particular desired geographical location or area, at a particular terminal (mobile or fixed), or at one or more groups of terminals at the same or different locations. It should be noted that the terms “AAS” or “AAS device” are used interchangeably herein.

One embodiment of an AAS device uses AAS configuration information that defines various dynamic beam forming operations performed by the Transceiver Bank, the Radio Distribution Network (RDN) and the Antenna Array on one or more reference signals applied to an input of the AAS (e.g., a Transceiver input) to generate a beam from the processing of the one or more reference signals where such beam may be directed at a particular terminal (mobile or fixed), one or more groups of terminals, or a geographical area. The directed beam of the one or more reference signals being a logical port of the AAS in general and more particularly a logical port of the Antenna Array. The AAS configuration information thus defines a dynamic mapping of one or more logical ports (i.e., one or more processed reference signals into a beam) to the AAS. The term “reference signal” refers to an electrical signal having characteristics defined by a communication standard (i.e., its particular pertinent protocols) of a communication system within which the AAS is being used. Such characteristics include, for example, the particular frequency spectrum, and amplitude within a defined portion of the spectrum.

The term ‘dynamic beam forming operations’ refers to certain tasks performed on one or more of the components of the AAS to form beams based on AAS configuration information applied to the AAS for a defined period of time (or a desired period of time). The dynamic beam forming operations can be performed for a defined period of time, or for as long as needed or desired, using any one or more of the antenna elements. A beam formed from a dynamic beam forming operation has a particular shape, physical range, power allocation, and power distribution for coverage of (i) a specific geographical area; (ii) a specific terminal (mobile or fixed) at a particular location; (iii) one or more groups of terminals (fixed or mobile) within one defined area or different defined areas. The particular information on which the dynamic beam forming operations are based is referred to as AAS configuration information.

The AAS configuration information is information that identifies the particular selected transceivers, the amount of power allocated to the particular selected transceivers, the particular routing of signal(s) applied to particular selected transceivers through selected switches of the RDN to the particular antenna elements needed to perform beam forming operations for a desired beam directed at a specific terminal (mobile or fixed), a particular geographical location or area, or one or more groups of terminals at the same location or at different locations.

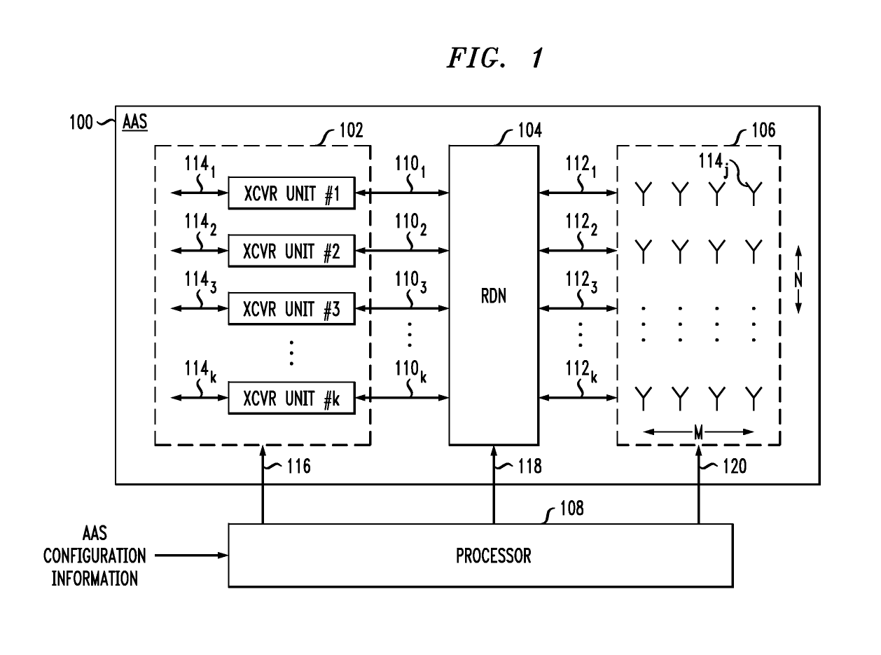

When the applied signal is a reference signal (which may comprise one or more signals), which is a signal defined by the communication network (i.e., is part of the specifications of the communication network), or defined by one or more communication standard (and their associated protocols) being followed by the communication network within which the AAS operates, the resulting beam formed from the dynamic beam forming operations to process this reference signal inputted to the AAS device (an embodiment of which is depicted in FIG. 1), is a logical port of the Antenna Array.

A logical port (or a generated beam of a reference signal) may or may not be generated for a defined time period. In many cases, the beam that is formed may be generated for as long as circumstances dictate. Each of the transceivers may include, as part of their circuitry, power amplifiers that can drive one or more of the antenna array elements via the Radio Distribution Network. The power amplifiers may include filters that serve to limit and/or define the frequency content of the signals applied to the transceivers. Further, each of the transceivers is also capable of imparting a certain phase to each of the applied signals. Thus, based on these capabilities of the transceivers and the radiation profile of the antenna array elements, the shape and direction of a beam can be designed as desired before it is generated. Yet further, the transceiver or transceivers to which a signal is applied may adjust the power level and the frequency content of the signal. The beam is thus designed and realized through the use of the circuitry discussed above, which may be part of a base station of a cellular communication network, or integral with the base station. The AAS operates within the cellular communication network or wireless communication network.

The terminals (mobile or fixed) at which the logical ports are directed can use the information received from the logical ports to perform certain communication network or communication standard defined tasks such as modulation, coherent detection, synchronization with different channels between mobile terminals. The beams formed using the AAS device embodiment in accordance with the method embodiment are not limited (or dedicated) to certain antenna elements, transceivers or RDN switches of the AAS. It will be understood that different transceivers, RDN switches and antenna elements can be used to form the same or different beams or logical ports at different times for different time durations. In other words, no particular combination of antenna elements, transceivers and routing switches on which dynamic beam forming operations are performed are dedicated to any of the formed beams or logical ports.

Similar to a specification for a base station that describes the operation of the base station, the specification for an antenna can describe the various ports of the antenna and the characteristics of each of said ports. Thus, a specification for an antenna, such as the Antenna Array of the AAS device embodiment can comprise AAS configuration information that defines the dynamic mapping (i.e., dynamic beam forming operations) of an input reference signal, processed by the Transceiver Bank, RDN, and Antenna Array of the AAS resulting in a beam (i.e., a logical port) directed at a terminal or terminals, a group or groups of terminals, or a specific geographical area.

The AAS device embodiment operated, for example, as per the method embodiment is capable of forming different types of beams or beam configurations. For example, the following beam forming configurations can be performed: (1) Cell specific vertical or horizontal beam forming; (2) UE specific vertical or horizontal beam forming; (3) higher order MU-MIMO (Multi User Multiple Input Multiple Output) across all antenna ports both in azimuth and elevation dimensions; and (4) FD-MIMO (Full Dimension MIMO). In cell specific beam forming, the cell is separated by the beam formed either in the vertical or horizontal dimension. Alternatively, the beam specific to each UE can be formed. The AAS device embodiment can also be used to provide spatial multiplexing through such techniques as MU-MIMO and FD-MIMO, where for the latter technique a higher dimension of logical ports is utilized.

In one example embodiment, the components of the AAS form an integral device whereby the AAS is a single integral circuit having a common substrate (or a common circuit board) on which all of the circuitry for the Transceiver Bank, the Radio Distribution Network and Antenna Array are mounted. In another example embodiment, the AAS device may include a processor or controller that provides all of the control signals to the Transceiver Bank, the Radio Distribution Network and the Antenna Array respectively for performing beam forming, including the usage of logical ports, based on the AAS configuration information.

The signal or signals from which a beam is generated are applied to at least one transceiver of the Transceiver Bank, which amplifies or otherwise processes the signal or signals based on at least a certain amount of power provided to such at least one transceiver. The output of the at least one transceiver is routed through the RDN (Radio Distribution Network) by activating one or more of the controllable switches of the RDN to drive one or more of the antenna elements of the at least one Antenna Array. Each antenna element of the Antenna Array has a defined beam pattern or radiation pattern (of certain frequencies or set of frequencies) that results when a defined signal comprising certain frequency components within a frequency band having a certain range of amplitude or power value is used to drive the antenna element; this resulting beam pattern is referred to as the ‘radiation profile’ of the antenna element. This radiation profile may, for example, represent RF (Radio Frequency) characteristics of the Antenna Array where such characteristics are defined by the AAS configuration information that dictated how and which beam forming operations are performed. Thus, with a priori knowledge of the radiation profile of each of the antenna elements, an embodiment of the AAS device allows for the construction or design (or both) of a desired beam without having to actually apply a signal to the antenna elements. The formed beam can be predicted based on the radiation profile of the antenna elements and on the known characteristics of the signals applied to the AAS. The Antenna Array can be designed to have different groups of antenna elements with each group having a different radiation profile. Alternatively all antenna elements of an Antenna Array can have the same radiation profile.

One method embodiment performs the steps for various beam forming operations dictated by AAS configuration information (received by the AAS) to process one or more reference signals inputted into the AAS where some of these operations may be performed for a defined time period. All of the steps of this embodiment may be performed by an AAS that is integral with a base station of a cellular communication network within which the AAS operates. The AAS configuration information may originate from the communication network or may be generated by the network in complying with the communication standard (e.g., certain protocols) being followed by the communication network. For example, the base station (or other network equipment) may generate AAS configuration information based on rules (communication standard and associated protocols) of the cellular network and/or based on information (from operators or users of the network, for example) describing the current tasks needed to be performed to meet the demands of the network.

A base station integral with the AAS or capable of communicating with the AAS may generate various control signals based on AAS configuration information that it receives. The AAS configuration may be generated by one or more equipment of a communication network within which the AAS operates. The AAS configuration information or corresponding control signals associated with the AAS configuration information are applied selectively to the Transceiver bank, the Radio Distribution Network and the Antenna array of the AAS to cause the AAS to perform dynamic beam forming operations in accordance with the AAS configuration information on one or more reference signals applied to inputs of the AAS. In another embodiment, the AAS may have the proper processing capabilities to generate control signals from received AAS configuration information. In short, the AAS configuration information is converted to various control signals applied at the appropriate time to the various components of the AAS device. The control signals may be generated with the use of a (e.g., microprocessor, digital signal processor, microcontroller, controller, server, computer system or any combination thereof); the processor may be part of the AAS device or may be separate from the AAS device. The AAS may be allocated sufficient power to perform the required beam forming operations within any time constraint dictated by the AAS configuration information. A determination of the type and amount of resources (e.g., antenna elements, transceivers, time representing duration of the beam, and power requirements for the generation of the beam) needed to perform the beam forming operations may be done by the AAS based on the AAS configuration information. The resources needed to perform the beam forming operations are part of resource deployment tasks performed by the communication network within which the AAS operates. Thus, the AAS configuration information may be based on resource deployment tasks performed by the communication network in which the AAS operates.

The method embodiment determines if there are sufficient resources available to perform the desired beam forming operations to generate one or more beams. In particular, in order to form the desired beam, the AAS first determines, based on the AAS configuration information, the following: (i) the particular transceivers to be used; (ii) the particular switches in the RDN to be used, (iii) the particular antenna elements to be used; (iv) the amount of power used by the selected transceivers to drive the selected antenna elements; and (v) the proper amount of power to be allocated to the AAS to perform any one or more of various tasks using the logical port. If there are sufficient resources, then the AAS is operated so that the one or more beams are formed and used as a logical port as dictated by the communication network (or communication standard(s) of the communication network) within which the AAS operates; otherwise this method embodiment waits until sufficient resources are available to form the desired one or more beams. The beam forming operations are performed for a defined period of time based on any time constraints included in the AAS configuration information. Upon the lapsing of the time duration associated with the time constraint, the beam forming operation is terminated. Otherwise, the duration of the beam forming operations is performed to meet the requirements dictated by the AAS configuration information or dictated by the particular logical port being generated.

Referring to FIG. 1, an embodiment of an Active Antenna System (AAS) is depicted. For ease of explanation the AAS system will be described in the context of a communication network (e.g., a cellular or wireless communication network) operated in accordance with a communication standard (and associated protocols) with which the network and thus the AAS complies. One example of a communication standard is the 4G LTE standard. It should be noted, however, that the use of an embodiment of the AAS is not limited to any particular type of communication network or communication standard. The AAS embodiment comprises a Transceiver Bank 102 having a plurality of transceivers (transceiver unit 1, 2, 3, . . . , K) each of which has an input 114₁, 114₂, 114₃, . . . , 114_{K}; (K is an integer equal to 2 or greater) and each of which is coupled to one of a first set of I/Os (Input/Outputs) of Radio Distribution Network (RDN) 104. The first set of I/Os shown are 110₁, 110₂, 110₃, . . . , 110_{K}. The RDN 104 also has a second set of K I/Os (112₁, 112₂, 112₃, . . . , 112_{K}). Each of the second set of I/Os may be coupled to an I/O of Antenna Array 106. The Antenna Array comprises N rows of antenna elements each row having M columns (N and M are integers equal to 1 or greater) resulting in J antenna elements where J=1, 2, 3, . . . , N·M (J is an integer equal to 1 or greater). Each of the antenna elements (116₁, 116₂, 116₃, . . . , 116_{N·M}) inherently has an I/O portion as it can transmit and/or receive electromagnetic signals over the air. For example, electromagnetic signals received by one or more of the antenna array elements are routed to one or more of the second set (112₁, 112₂, 112₃, . . . , 112_{K}) of K I/Os of RDN 104, through the RDN 104 and then to one or more of the transceivers via first set of I/Os (110₁, 110₂, 110₃, . . . , 110_{K}) to appear at one or more of the set of I/Os (114₁, 114₂, 114₃, . . . , 114_{K}) after having been processed by one or more of the transceivers of Transceiver Bank 102. Conversely, one or more signals applied to one or more of the I/Os 114₁, 114₂, 114₃, . . . , 114_{K} of the Transceiver Bank 102 are processed and appear at one or more transceiver I/Os 110₁, 110₂, 110₃, . . . , 110_{K} through RDN 104 and to one or more antenna elements via I/Os 112₁, 112₂, 112₃, . . . , 112_{K} to generate a beam as part of a beam forming operation.

The particular power amplification by the transceivers, the particular routing through the RDN and the particular selection of antenna elements in performing such a beam forming operation are controlled by the control signals on signals paths 116, 118 and 120 respectively. The control signals applied to AAS 100 are shown as originating from processor 108 which generates such signals based on AAS configuration information applied to or received by the processor 108. It is understood that the AAS configuration information may be processed by one or more devices and/or circuits, microprocessor, digital signal processor or any combination thereof to generate the control signals for the various blocks of the AAS 100; various embodiments discussed herein are not limited to the use of a processor, such as processor 108, to generate the control signals from the AAS configuration information. Other implementations can be realized wherein the AAS configuration information is converted to control signals by the AAS having internal circuitry or internal processor circuitry to allow an embodiment of the AAS to perform beam forming including beams formed to operate as logical ports. Thus, by applying the proper power to selected transceivers to which an input signal is applied, by combining the proper antenna elements through the proper routing of the signals through the RDN, a beam forming operation can be performed wherein the shape, range, and power of the formed beam can be selectively controlled. The logical ports are formed from a reference signal and can be directed at a particular mobile or fixed terminal that is in communication with a cellular network using an embodiment of the AAS as part of the base station radio circuitry.

The AAS configuration information may be generated by network circuitry or network servers or computers that operate in accordance with the communication standard (and associated protocol) being followed by the wireless or cellular communication network within which a base station comprising at least an AAS device embodiment —one example embodiment of which is shown in FIG. 1. The AAS configuration information may be based on or may be generated from various functions performed by one or more node elements of the communication network in establishing communications between two mobile terminals (for example) or for maintaining a communication session once it has been established where the communication session and the establishment of same are performed in accordance with the communication standards being the followed by the communication network. A node element is equipment or a group of equipment that performs certain defined functions within a communication network. Examples of a node element include base stations, communication servers, mobile or fixed terminals. The node elements are part of a communication network within which the AAS operates and each such node elements perform specifically defined functions within the communication network.

Even though various embodiments of the AAS described above can be used at different base stations to perform beam forming operations in a dynamic manner, certain owners of base stations may want the AAS to operate in the same manner as most antenna systems currently operate. For ease of explanation and discussion, these current systems will hereinafter be referred to as “legacy systems.” A typical legacy system used at a base station comprises radio equipment (for example, amplifiers, filters, modulation circuitry typically coupled to a transceiver) connected to an antenna; the antenna may be a single antenna with a specific radiation profile or may comprise a plurality of antenna elements each having the same or different radiation profiles. The antenna forms a beam consistent with the characteristics of its radiation profile when a signal comprising one or more baseband signals are applied to the AAS. In the case of an antenna implemented with a plurality of antenna elements, a beam consistent with the combination of the radiation profiles of the antenna elements is formed. In sum, such an antenna system, unlike the active antenna system (AAS) of FIG. 1 described above, is designed to generate a specific beam based on particular signal(s) applied to the antenna or antenna elements for an indefinite period of time. Such antenna systems are static antenna systems (SAS) in that the signal(s) from the radio equipment that are used to form the beam do not change. Also, the beam formed does not change. The applied signals, which are baseband signals, are modulated in accordance with the information being transmitted. Accordingly, the resulting beam does not change its shape (e.g., beam width of main lobe) or direction and remains the same as long as the radio equipment applies the proper input reference signal(s) to the antenna. Thus, the legacy systems have static antenna systems.

Legacy systems typically comprise radio equipment having one or two physical antenna ports and for each port one end of a cable is connected to the port and the other end of the cable is connected to the antenna (single antenna or multiple antenna elements). Each antenna port of the radio equipment thus provides physical access to the output signal of the radio equipment. The output signal of the radio equipment is the beam signal which is applied to the antenna.

It will be shown that the AAS embodiment discussed above can be configured to operate in the same manner as antenna systems used in legacy systems. In particular, the AAS receives AAS configuration information that causes various control signals to be generated by microprocessor 108 to select a specific set (or grouping) of transceivers (of Transceiver Bank 102) connected to a specific set of antenna elements (of antenna 106) via a specific set of switches of RDN 104. Such an AAS embodiment is shown in FIG. 1A. It should be noted that the AAS in FIG. 1A in all aspects operates in the same manner as the AAS of FIG. 1 except that it is configured by AAS configuration information to operate as a legacy antenna system. Furthermore, the AAS of FIG. 1A physically is packaged to provide physical access to the beam signal present at the outputs of radio equipment 100A corresponding to the groupings of transceiver units selected to drive the static beam signal.

Referring to FIG. 1A, there is shown a static beam AAS device wherein the transceiver bank 102 and the RDN 104 are coupled to each other such that a certain selected group of one or more transceivers (transceivers unit 1, . . . , k) have their outputs coupled (directly or indirectly) to certain one or more switches within RDN 104. Although not shown in FIG. 1A, there may be additional processing equipment coupled between the outputs of transceiver bank 102 and inputs of RDN 104 in series with each paths 110₁, 110₂, . . . , 110ₖ. When no such processing equipment exists for a particular path (110₁, 110₂, . . . , 110ₖ), the transceiver unit associated with that path is said to be directly coupled to the RDN 104. The transceiver bank 102 and RDN 104 form radio equipment 100A as shown in FIG. 1A. Radio equipment 100A is equivalent to radio equipment of a legacy in that (1) its output(s) (a subset of 112₁, . . . , 112ₖ) are physically accessible, and (2) the signals the particular subset of paths (112₁, . . . , 112ₖ) comprise the beam signal which when applied to the antenna 100B cause the desired static beam to be generated. Moreover, as with radio equipment of legacy systems, the radio equipment 100A of FIG. 1A is capable of having one or more antenna ports each of which can drive an antenna (or a group of antenna elements) to generate a desired static beam. In particular, for FIG. 1A, an antenna port comprises a group of selected transceivers from Transceivers Bank 102 coupled to one or more selected switches of RDN 104. The outputs of the selected RDN switches represent the output of the antenna port, which is physically accessible to operators of the AAS device. Accordingly, several groupings of transceiver units can be selected along with corresponding groupings of switches constituting several antenna ports. Thus, FIG. 1A can operate in the same manner as legacy systems; that is, signals present at an antenna port of a radio equipment are connected to an antenna to generate a static beam that may carry, at times, information (implemented by modulating the signals applied to the transceiver grouping) that is to be transmitted by the antenna. The connection from radio equipment 100A to antenna 100B is physically accessible to an operator of the AAS of FIG. 1A. Because the configuration of FIG. 1A is similar or equivalent to a legacy system, an operator can measure, view or combine the outputs of radio equipment 100A; these outputs represent the aggregate outputs of the groupings of the transceivers for the particular static beam. A static beam is a particular electromagnetic radiation pattern emitted by an antenna and having non-varying beam characteristics. The beam characteristics comprise the beam width (e.g., the half power beam width), the power of the beam, and the direction of the beam (i.e., direction of the main lobe of the beam). It should be noted that the power of the generated static beam is the aggregate of the power portions allocated among the various transceivers of a grouping (or set) of transceivers.

The antenna 100B of the system of FIG. 1A can receive signals via one of its antennas (or group of antennas), which routes (via switches of RDN 104) the received signals to the one or more connected transceivers having outputs on paths 114₁, 114₂, . . . , 114ₖ. Thus, it should be noted that the paths associated with Transceiver Bank 102 and RDN 104 can serve as input or output paths. That is, paths 114, 110 and 112 can be input or output paths depending on the origin of the signal passing therethrough.

AAS configuration information dictates the operation of the AAS. Depending on the AAS configuration information provided to microprocessor 108, the AAS can operate as a legacy system or an active antenna system or both. That is, with sufficient number of antenna elements, RDN switches and transceiver units, the AAS of FIG. 1 can operate as a legacy system (an example of which is shown in FIG. 1A) and as an active system as shown in FIG. 1 simultaneously. Further, an AAS device such as the one shown in FIG. 1 can operate as a legacy system (as shown in FIG. 1A) for an undefined period of time without having to use the same antennas or antenna elements, the same switches or the same group of transceivers for that undefined period time. In particular, a certain grouping of transceivers, switches and antenna elements can be selected to generate a beam to be used for a legacy base station. It will be readily understood that the same beam (with same beam width and output power) can be formed using other combinations of transceivers, switches and antenna elements. A static beam can be formed using various combinations of transceivers, switches and antenna elements. There are no particular transceivers, switches and antenna elements or particular groupings thereof, which are dedicated to the forming of any particular beam. Further, no particular combination of different groupings of transceivers, switches and antenna elements define a particular static beam. For example, the same transceiver grouping, but different groupings the switches and antenna elements can be used to generate the same static beam. Also, an AAS device operated as a legacy system can switch to other types of operation based on the configuration information received by the AAS. The AAS embodiments shown in FIGS. 1 and 1A show that the AAS can operate as an active antenna system or a legacy antenna system at different times or at the same time providing there are sufficient transceivers, switches and antenna elements. It is the AAS configuration information that dictates the operation of the AAS device. Even though static beams are generated in accordance with the AAS configuration information, the propriety of such beams still need to be confirmed.

One approach for confirming the propriety of a generated static beam is to define a particular location in terms of distance and direction from a base station at which the characteristics (i.e., defined parameters) of a static beam is measured. A static beam is said to be acceptable if its characteristics (e.g., half power beam width, power of main lobe) measurements at the defined location match (within reasonable tolerances) the corresponding measurements deemed to be correct by operators the communication system in which the AAS device is being used. The operators of a communication system within which the AAS operates define the tolerances. Accordingly, the following method for confirming the propriety of a generated static beam comprises the steps of: storing in a memory of the AAS device characteristic values of a generated proper static beam. Also, acceptable parameter values for the static beam at a specifically defined geographic location are stored in the memory. The static beam is then generated and then its characteristic values (i.e., parameter values) are indeed measured at the specified geographic location. Then the measured values are compared to their corresponding stored values to determine if there is a match (within reasonable tolerances) between the two sets of values. A generated static beam is declared acceptable when there is a match (within tolerances) between corresponding parameters. Alternatively, an operator having access to outputs of the groupings of the transceiver used to generate the static beam, can measure and properly combine these outputs to determine if the proper static beam signal is being transferred to the antenna elements; this is another way of confirming the propriety of a generated static beam.

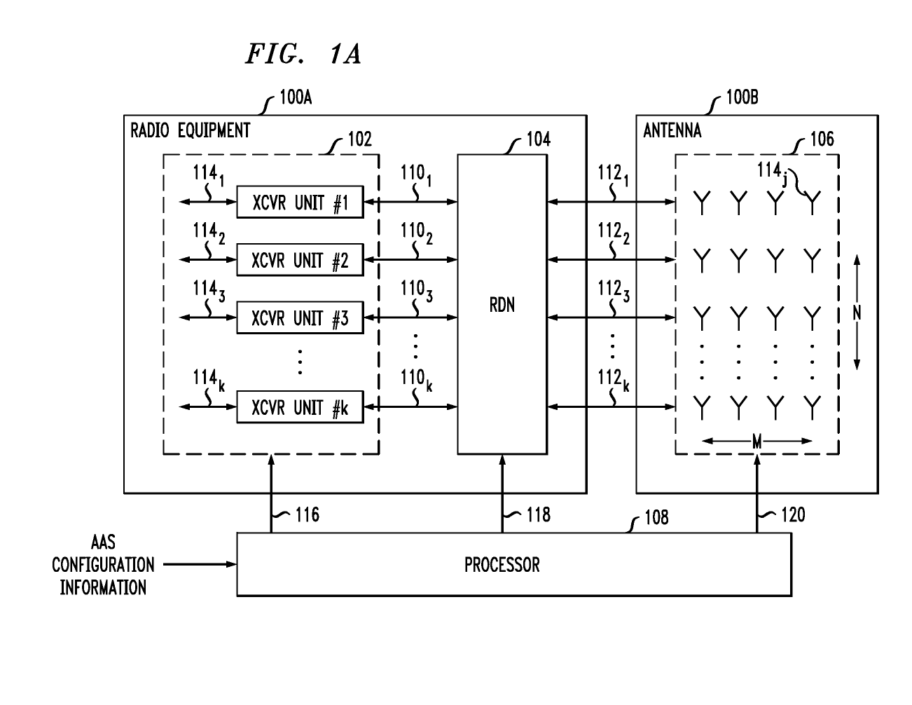

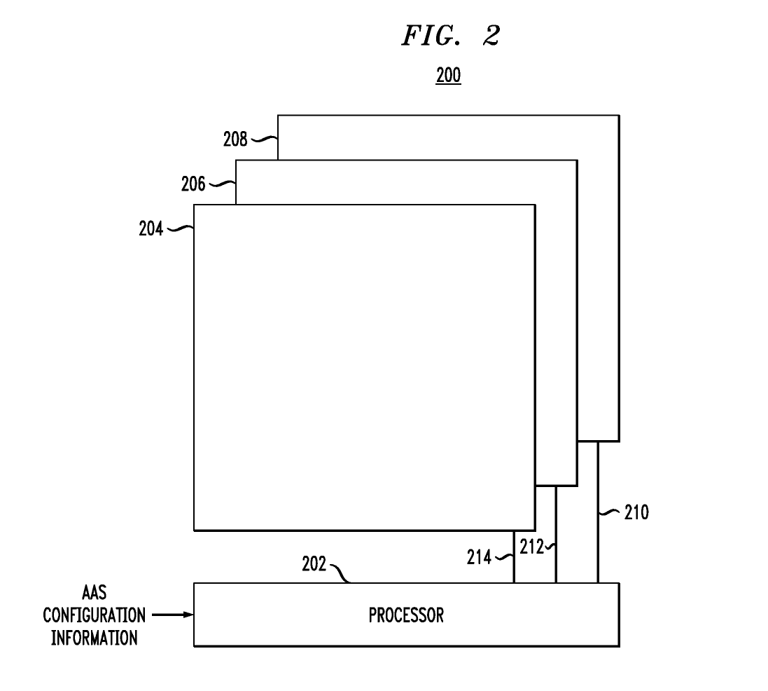

Referring to FIG. 2, a particular architecture 200 for three AASs is shown. AAS 204, 206 and 208 are substantially similar in operation and configuration to AAS 100 discussed above. Processor 202 receives AAS configuration information for all three AASs. AAS configuration information may be labeled in any well known manner to indicate for which AAS a particular block of AAS configuration information is destined. Processor 202 receives AAS configuration information for the three AASs (204, 206 and 208), determines the destination of the received AAS configuration information and generates the proper control signals for the proper AAS. Control signals for AAS 204 are generated on path 214, for AAS 206 on path 212 and for AAS 208 on path 210. One particular application of the AAS architecture 200 may be the coverage on different parts of a cell that is part of a cellular communication network as shown in FIG. 3.

Referring to FIG. 3, cell 300 is divided into three geographical areas as shown. The system shown in FIG. 2 is used to provide antenna coverage for the entire cell by assigning a separate AAS to each portion of the cell as shown. The different AASs receive control signals from a single processor where such control signals are generated from AAS configuration information received for a particular AAS.

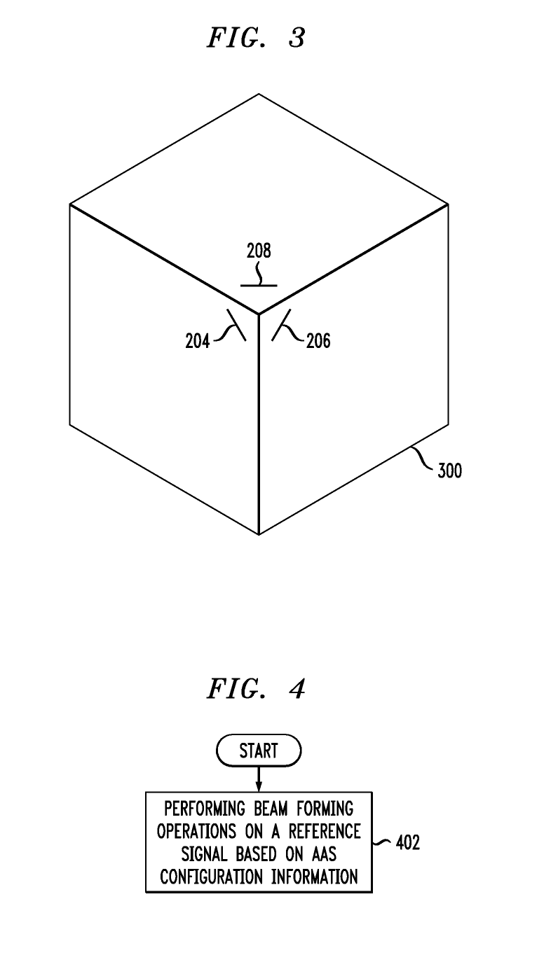

Referring to FIG. 4, a method embodiment is shown. An AAS is first provided and a reference signal is applied to one of its inputs. For the embodiment shown in FIG. 1, the reference signal is applied to an input of one of the Transceivers of the Transceiver Bank 102. Thus, in step 402, the method embodiment provides an AAS that performs beam forming operations to process a reference signal applied to an input of the AAS where the beam forming operations are based on AAS configuration information received by the AAS. The AAS receives AAS configuration information dictating the particular beam forming operations to be performed on the various components of the AAS to process the input signal resulting in a beam that represents a logical port of the Antenna Array of the AAS. The AAS configuration information may be received by a processor that converts such information to control signals to cause the beam forming operations to be performed with the appropriate components of the AAS at the appropriate time.

The beam forming operations are performed for a period of time defined by the AAS configuration information. The length of time may be defined by the AAS configuration information. The length of time for which the beam forming operations are performed may also be based on particular tasks being performed by a communication network within which the AAS operates. For example, the particular information being conveyed over the logical port generated by the AAS may be information needed to perform the steps of a particular protocol of a standard being followed by a communication network within which the AAS operates. Prior to performing beam forming operations to process the input signal, the AAS determines whether there are sufficient resources available to perform the beam forming operations required or dictated by the received AAS configuration information. The resources may be the various components of the AAS as described supra (with respect to FIG. 1) and also the amount of power allocated to the AAS or the amount of power allocated to the logical ports of the AAS.

The AAS configuration information may be received directly by the AAS or may be received by a processor in communication with the AAS which processor converts the AAS configuration information to control signals. The control signals are applied to the AAS by the processor which may form part of the AAS or may be in communication with the AAS. Further, the AAS may receive a multiple of AAS configuration information associated with a multiple of logic ports which ports can then be generated simultaneously based on their respective AAS configuration information. It will be readily obvious that different groups of Transceivers, RDN switches and antenna elements may be used simultaneously to generate different logical ports simultaneously based on the AAS configuration information for different signals applied to different inputs of the AAS. Even further, the AAS may generate different logical ports at different times as called for by the AAS configuration information for the different logical ports. The AAS configuration information may be based on protocols being performed by the communication network within which the AAS operates. These protocols may be performed by various equipment or nodes of the communication network.

The particular embodiments disclosed above are illustrative only, as the disclosed subject matter may be modified and practiced in different but equivalent manners apparent to those skilled in the art having the benefit of the teachings herein. It will be apparent to persons skilled in the relevant art(s) that various changes in form and detail can be made herein without departing from the spirit and scope of the various example embodiments discussed herein. No limitations are intended to the details of construction or design herein shown, other than described in the claims below. It is therefore evident that the particular embodiments disclosed above may be altered or modified and all such variations are considered within the scope of the disclosed subject matter. Thus, this description of various embodiments should not be limited by any of the above-described exemplary embodiments, but should be defined only in accordance with the following claims and their equivalents. Accordingly, the protection sought herein is as set forth in the claims below.

What is claimed is:

1. A static beam AAS device comprising:
a Transceiver Bank;
a Radio Distribution Network (RDN) coupled to the Transceiver Bank; and
an Antenna Array comprising a plurality of antenna elements where a selected set of transceivers of the Transceiver Bank is coupled to selected switches of the Radio Distribution Network coupled to selected antenna elements to generate a static beam in response to one or more reference signals applied to the Transceiver Bank and AAS configuration information received by the static beam AAS device.

2. The static beam AAS device of claim 1 where the AAS configuration information is received by the static beam AAS from one or more node elements of a communication network within which the AAS operates.

3. The static beam AAS device of claim 1 where such device is integral with a base station of a cellular communication network within which the AAS operates.

4. The static beam AAS device of claim 1 where the one or more reference signals are defined by one or more specifications of a communication network within which the static beam AAS device operates.

5. The static beam AAS device of claim 1 where the one or more signals are defined by at least one communication standard being followed by a communication network within which the AAS operates.

6. The static beam AAS device of claim 1 where the generated static beam directed at a desired spatial location.

7. The static beam AAS device of claim 1 where the generated beam directed at one or more mobile terminals.

8. The static beam AAS device of claim 1 further comprising a processor coupled to the Transceiver Bank, the RDN and the Antenna Array, said processor being configured to receive the AAS configuration information and convert said information to control signals used by the Transceiver Bank, the RDN and Antenna Array to generate the static beam.

9. The static beam AAS device of claim 8 where the processor is one of a microprocessor, a digital signal processor, a controller, a server and a computer system.

10. The static beam AAS device of claim 1 where the AAS configuration information on which the generated beam are based define RF (Radio Frequency) characteristics of the antenna elements of the Antenna Array.

11. The static beam AAS device of claim 1 where the AAS configuration information is based on resource deployment tasks performed by a communication network in which the AAS operates.

12. A method for operating a static beam Active Antenna System (AAS) device, the method comprises:
selecting, by the static beam AAS, a set of transceivers from a Transceiver Bank, a set of switches from a Radio Distribution Network (RDN), and a set of antenna elements from an antenna array beam to generate a static beam from signals applied to the selected transceivers and based on AAS configuration information received by the static AAS device.

13. The method of claim 12 where the static beam AAS comprises the Transceiver Bank coupled to the RDN which is coupled to the Antenna array.

14. The method of claim 12 where the static beam is generated for an undefined period of time defined by the received AAS configuration information.

15. The method of claim 12 where the static beam is generated for a period of time having a length based on a particular tasks being performed by a communication network within which the AAS operates.

16. The method of claim 12 where the generation of the static beam comprises first determining whether there are sufficient resources to generate such a beam.

17. The method of claim 16 where the resources comprise one or more transceivers, one or more switches of an RDN and one or more antenna elements of an antenna array.

18. The method of claim 12 where different groups of transceivers, switches and antenna elements can be used to generate the same static beam.

19. The method of claim 18 where power of the generated static beam is allocated among the selected set of transceivers.

20. The method of claim 12 where the AAS configuration information is based on protocols performed by equipment of a communication network in accordance with a communication standard being followed by the communication network within which the static beam AAS operates.
